(19) United States
(12) Patent Application Publication
(10) Pub. No.: US 2009/0200999 A1
(43) Pub. Date: Aug. 13, 2009

(54) VOLTAGE REGULATOR WITH COMPENSATION AND THE METHOD THEREOF

(75) Inventor: Chih-Hong Lou, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/028,020

(22) Filed: Feb. 8, 2008

(51) Int. Cl. G05F 1/575

(52) U.S. Cl. 323/280

(57) ABSTRACT

A voltage regulator including a transconductance amplifying unit, a transresistance amplifying unit, a feedback unit, a differential amplifying unit, and a compensation capacitor. The transconductance amplifying unit includes two inputs for receiving a feedback voltage and a reference voltage, and includes an output for outputting a current. The transresistance amplifying unit includes an input for receiving the current, and transforming the current into an output voltage. The feedback unit generates the feedback voltage with reference to the output voltage. The differential amplifying unit includes two inputs for receiving the feedback voltage and the reference voltage, and includes an output for outputting a differential voltage. The compensation capacitor is coupled between the output of the differential amplifying unit and the input of the transresistance amplifying unit.

### BACKGROUND OF THE INVENTION

1. Field of the Invention

The invention relates to a voltage regulator, and more particularly to the compensation for a voltage regulator.

2. Description of the Related Art

The stability of performance of circuits having feedback is improved by providing compensation so as to increase phase margin. A well known technique for improving phase margin takes advantage of the Miller Effect, by adding a Miller-compensating capacitance in parallel with a gain stage, e.g., the output stage of a two stage amplifier circuit.

A problem arises when the load capacitance seen by a circuit having compensating capacitance such as Miller-compensating capacitance becomes large. This requires the compensating capacitance to increase in value in order to maintain stability. Larger compensating capacitance, however, occupies more physical space. This is not a luxury that can be afforded in an environment where more circuits are integrated onto the same die, which, of course, is the trend.

FIG. 1 is a schematic diagram of a conventional differential amplifier. Differential amplifier 100 structure is two stages, where the first stage 10′ being a folded-cascade differential amplifier, and the second stage 12′ being a Miller-compensated PMOS device amplifier. Capacitor C1 is connected between an output node 36′ and a current mirror 54′ comprising NMOS devices 104 and 106.

### BRIEF SUMMARY OF THE INVENTION

Voltage regulators are provided. An exemplary embodiment of a voltage regulator comprises a transconductance amplifying unit, a transresistance amplifying unit, a feedback unit, a differential amplifying unit, and a compensation capacitor. The transconductance amplifying unit comprises two inputs for receiving a feedback voltage and a reference voltage, and comprises a first output for outputting a first current. The transresistance amplifying unit comprises a first input for receiving the first current, and transforming the first current into an output voltage. The feedback unit generates the feedback voltage with reference to the output voltage. The differential amplifying unit comprises two inputs for receiving the feedback voltage and the reference voltage, and comprises an output for outputting a differential voltage. The compensation capacitor is coupled between the output of the differential amplifying unit and the first input of the transresistance amplifying unit.

Compensation methods for voltage regulators are also provided. A first current is generated according to a feedback voltage and a reference voltage. The first current is transformed into an output voltage. The feedback voltage is obtained with reference to the output voltage. A differential voltage is generated to one terminal of a capacitor according to the feedback voltage and the reference voltage. The first current is provided to another terminal of the capacitor.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional differential amplifier; and

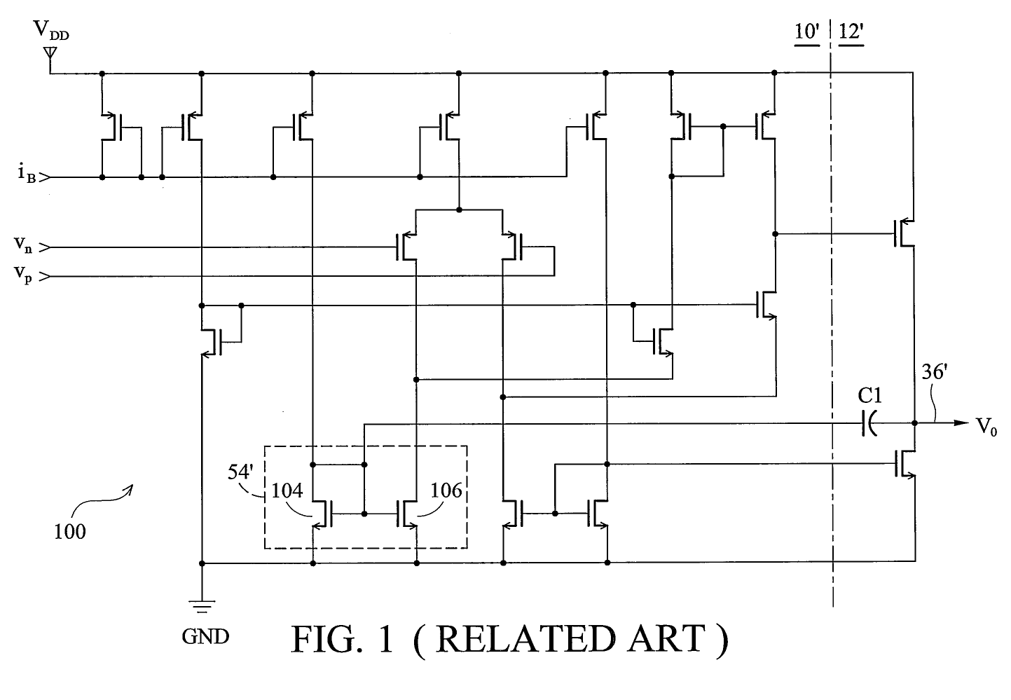

FIG. 2a is a schematic diagram of an exemplary embodiment of a voltage regulator;

FIG. 2b is a schematic diagram of an exemplary embodiment of the voltage regulator shown in FIG. 2a;

FIG. 3 is a flowchart of an exemplary embodiment of a compensation method;

FIG. 4a is a schematic diagram of another exemplary embodiment of a voltage regulator;

FIG. 4b is a schematic diagram of an exemplary embodiment of the voltage regulator shown in FIG. 4a; and

FIG. 5 is a flowchart of another exemplary embodiment of a compensation method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

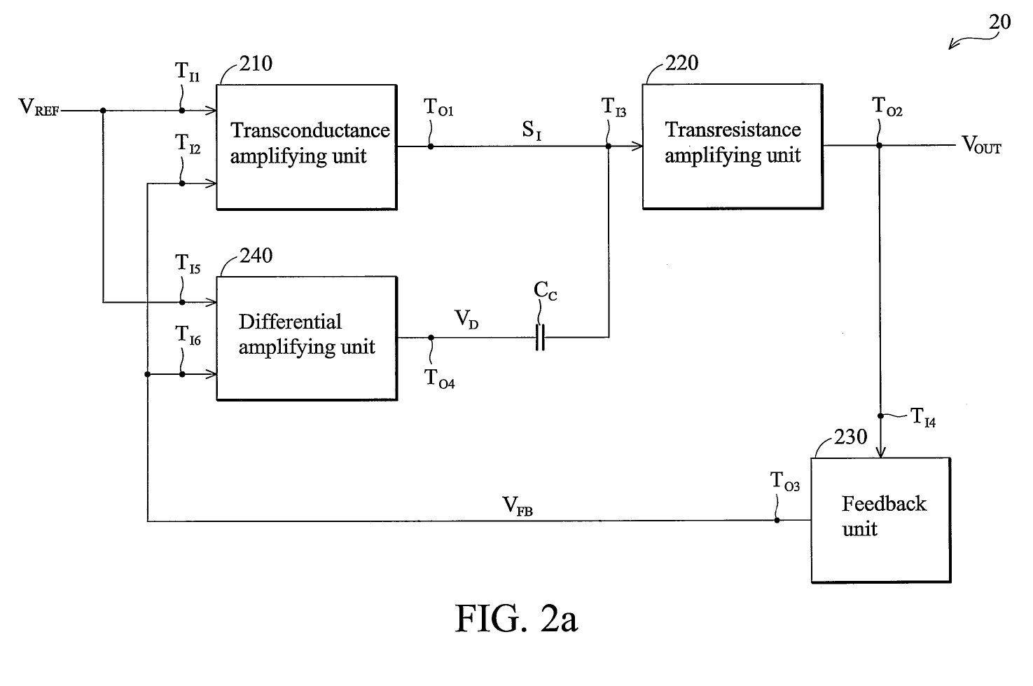

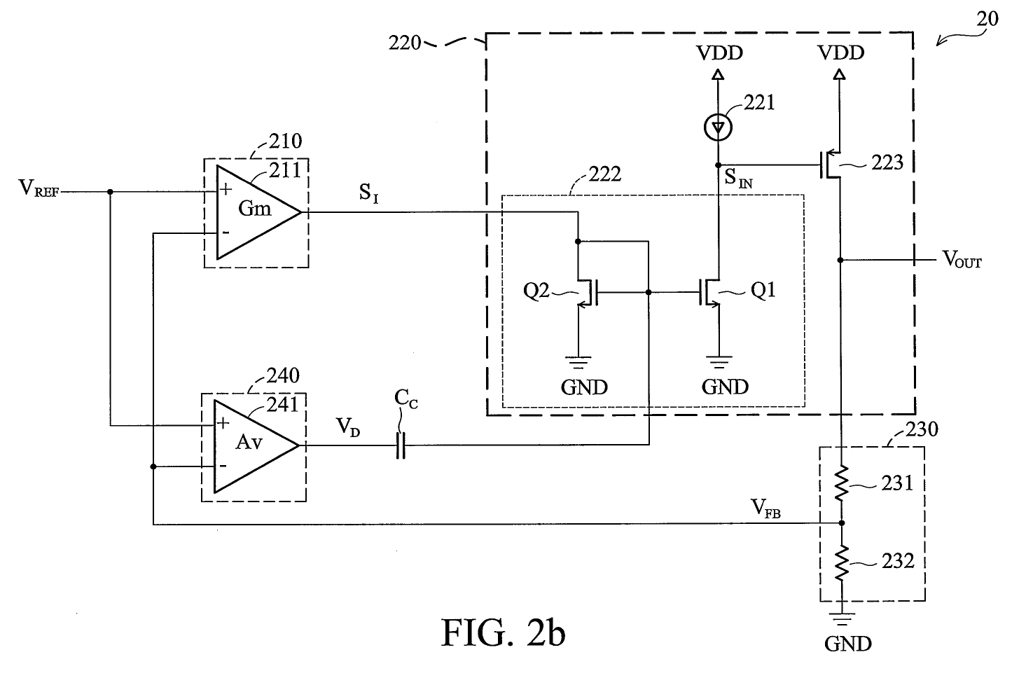

FIG. 2a is a schematic diagram of an exemplary embodiment of a voltage regulator. The voltage regulator 20 comprises a transconductance amplifying unit 210, a transresistance amplifying unit 220, a feedback unit 230, a differential amplifying unit 240, and a compensation capacitor Cc.

The transconductance amplifying unit 210 comprises inputs T_{I1}, T_{I2} for receiving a reference voltage V_{REF} and a feedback voltage V_{FB}, respectively, and comprises an output T_{O1} for outputting current S_{I}. The transresistance amplifying unit 220 comprises an input T_{I3} for receiving the current S_{I} and transforms the current S_{I} into an output voltage V_{OUT}. Feedback unit 230 generates the feedback voltage V_{FB} with reference to the output voltage V_{OUT}. The differential amplifying unit 240 comprises inputs T_{I5}, T_{I6} for receiving the reference voltage V_{REF} and the feedback voltage V_{FB}, respectively, and comprises an output T_{O4} for outputting a differential voltage V_{D}. The compensation capacitor C_{C} is coupled between the output T_{O4} of the differential amplifying unit 240 and the input T_{B} of the transresistance amplifying unit 220.

FIG. 2b is a schematic diagram of an exemplary embodiment of a voltage regulator 20 shown in FIG. 2a. The transconductance amplifying unit 210 comprises a transconductance amplifier 211 for transforming a voltage difference between the feedback voltage V_{FB} and the reference voltage V_{REF} into the current S_{I}.

The transresistance amplifying unit 220 amplifies the current S_{I} to generate expanded current S_{IN} and transforms the expanded current S_{IN} into the output voltage V_{OUT}. The expanded current S_{IN} may be N times of the current S_{I}. The transresistance amplifying unit 220 comprises a current generator 221, a current mirror 222, and a pass transistor 223. The current mirror 222 obtains the expanded current S_{IN} from the current generator 221 according to the current S_{I}. The pass transistor 223 generates the output voltage V_{OUT} according to the expanded current S_{IN}.

The feedback unit 230 comprises a voltage divider having resistors 231 and 232 connected in series between the output voltage V_{OUT} and a low voltage source, e.g. a ground voltage GND. The feedback voltage V_{FB} is generated by voltage division of the output voltage V_{OUT}.

The differential amplifying unit 240 comprises a voltage amplifier, such as differential amplifier 241, for amplifying a voltage difference between the feedback voltage V_{FB} and the reference voltage V_{REF}. In this embodiment, a non-inverting input (+) of the differential amplifier 241 is coupled to a non-inverting input (+) of the transconductance amplifier 211 and an inverting input (−) of the differential amplifier 241 is coupled to an inverting input (−) of the transconductance amplifier 211.

A feedback loop gain of the compensation capacitor Cc can be increased by Av times due to the differential gain Av of the differential amplifier 241, and the current S_{I} can be multiplied by N with the current mirror 222. Therefore, the compensation loop gain of the voltage regulator 20 is Av times that of the conventional differential amplifier 100. In additional, the compensation loop gain of the voltage regulator 20 is Av*N times that of another conventional technology which only utilizing a Miller-compensating capacitance in parallel with a gain stage.

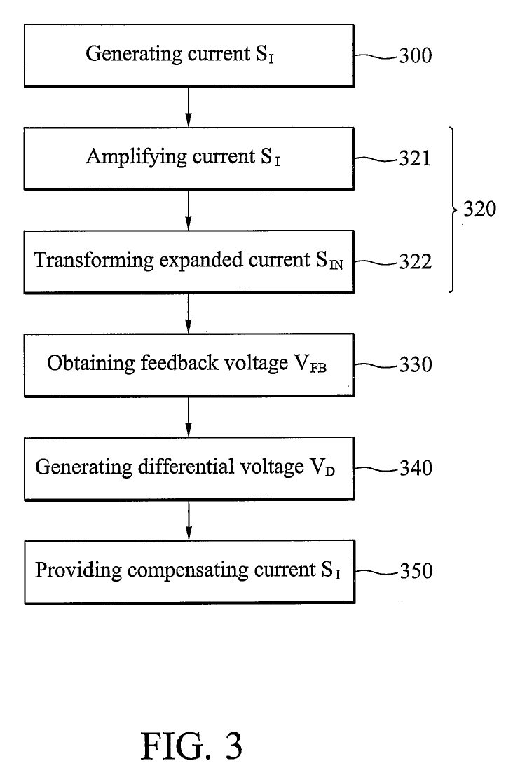

FIG. 3 is a flowchart of an exemplary embodiment of a compensation method. The compensation method can be applied in a voltage regulator. With reference to FIG. 2a, current S_{I} is generated according to the feedback voltage V_{FB} and the reference voltage V_{REF} (step 300). In this embodiment, the current S_{I} is generated by the transconductance amplifying unit 210, such as the transconductance amplifier 211. The transconductance amplifying unit 210 generates current S_{I} according to a voltage difference between the feedback voltage V_{FB} and the reference voltage V_{REF}.

The current S_{I} is transformed into an output voltage V_{OUT} (step 320). In this embodiment, the current S_{I} is amplified to obtain an expanded current S_{IN} (step 321) and then the expanded current S_{IN} is transformed to obtain the output voltage V_{OUT} (step 322).

With reference to FIG. 2b, the current mirror 222 is utilized to amplify the current S_{I} for obtaining the expanded current S_{IN} and then the pass transistor 223 is utilized to transform the expanded current S_{IN} into the output voltage V_{OUT}. An input terminal of the current mirror 222 is coupled to a first terminal of the compensation capacitor Cc. The feedback voltage V_{FB} is obtained with reference to the output voltage V_{OUT} (step 330). In this embodiment, the feedback voltage V_{FB} is obtained by voltage division of the output voltage V_{OUT}.

A differential voltage V_{D} is generated to a second terminal of the compensation capacitor Cc according to the feedback voltage V_{FB} and the reference voltage V_{REF} (step 340). In this embodiment, the differential voltage V_{D} is generated by the differential amplifier 241 according to a voltage difference between the feedback voltage V_{FB} and the reference voltage V_{REF}. The first terminal of the compensation capacitor Cc is coupled to the current S_{I} (step 350), thus forming a feedback loop. In this embodiment, the first terminal of the compensation capacitor Cc is coupled to the output T_{O1} of the amplifying unit 210, compensating the current S_{I} through the compensation capacitor Cc.

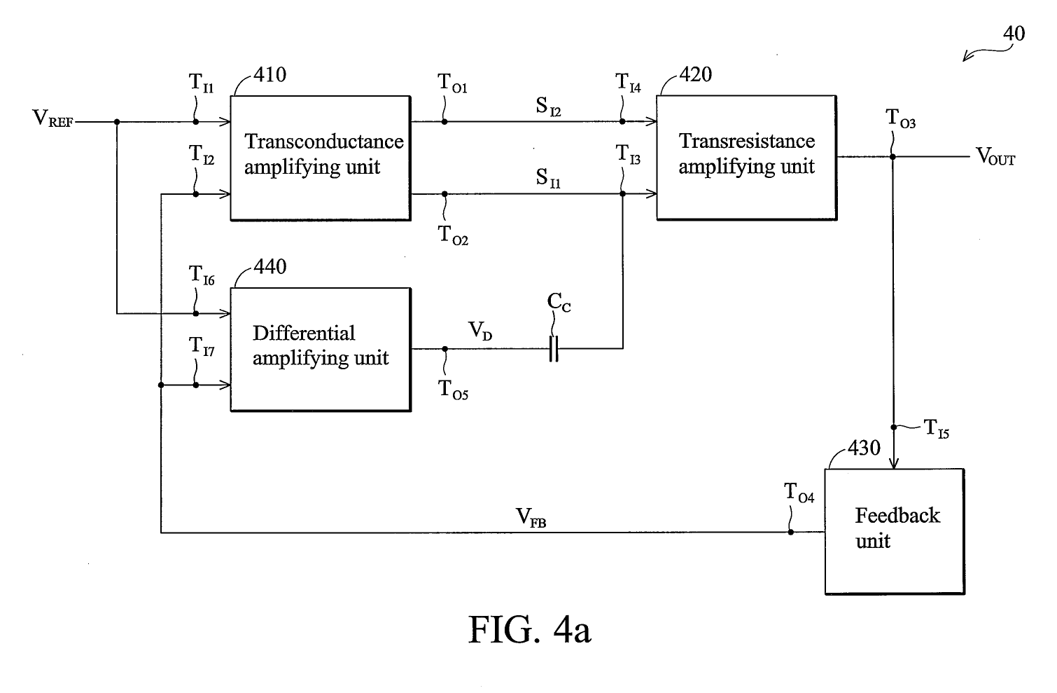

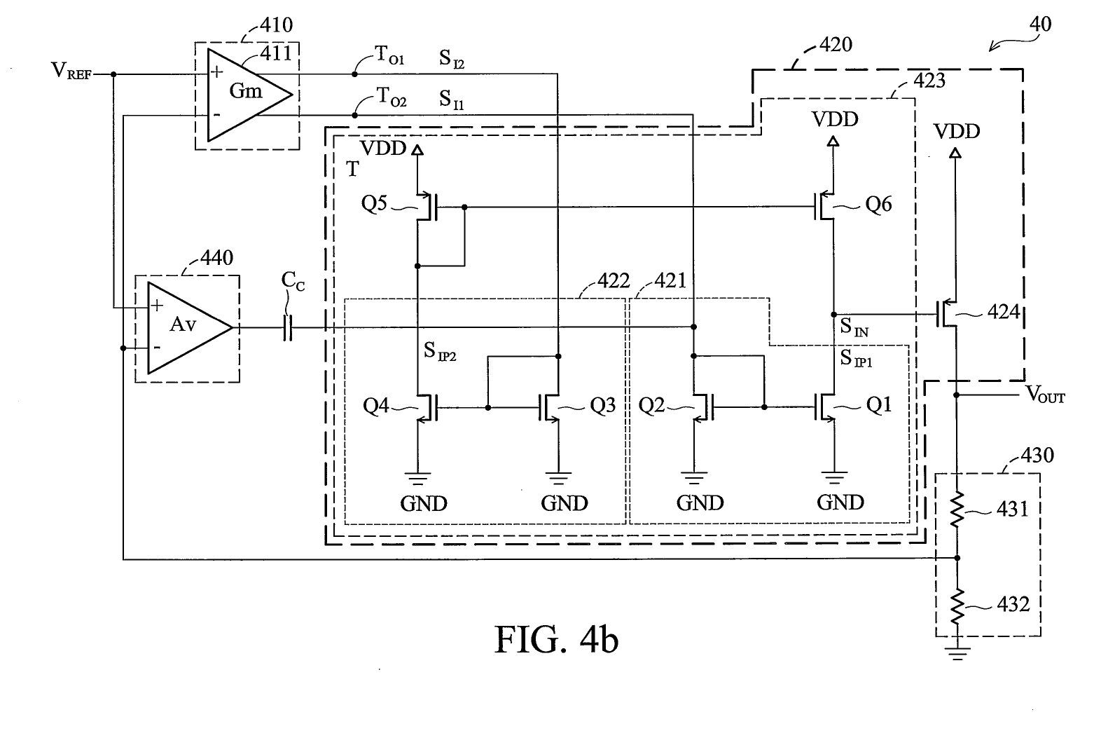

FIG. 4a is a schematic diagram of another exemplary embodiment of a voltage regulator. The voltage regulator 40 comprises a transconductance amplifying unit 410, a transresistance amplifying unit 420, a feedback unit 430, a differential amplifying unit 440, and a compensation capacitor Cc.

The transconductance amplifying unit 410 comprises inputs T_{I1}, T_{I2} for receiving a reference voltage V_{REF} and a feedback voltage V_{FB}, respectively, and outputs T_{O1} and T_{O2} for outputting currents S_{I2} and S_{I1}, respectively. The transresistance amplifying unit 420 comprises inputs T_{I3}, T_{I4} for receiving the currents S_{I1}, and S_{I2}, respectively, and transforms the current S_{I1} into an output voltage V_{OUT} according to the current S_{I2}. The feedback unit 430 generates the feedback voltage V_{FB} with reference to the output voltage V_{OUT}. The differential amplifying unit 440 comprises inputs T_{I6}, T_{I7} for receiving the reference voltage V_{REF} and the feedback voltage V_{FB}, respectively, and comprises an output T_{O5} for outputting a differential voltage V_{D}. The compensation capacitor Cc is coupled between the output T_{O5} of the differential amplifying unit 440 and the input T_{I3} of the transresistance amplifying unit 420.

FIG. 4b is a schematic diagram of an exemplary embodiment of the voltage regulator 40 shown in FIG. 4a. The transconductance amplifying unit 410 comprises a transconductance amplifier 411 for transforming a voltage difference between the feedback voltage V_{FB} and the reference voltage V_{REF} into the currents S_{I1} and S_{I2}. The transresistance amplifying unit 420 amplifies the current S_{I1} to generate an expanded current S_{IN} according to the current S_{I2} and transforms the expanded current S_{IN} into the output voltage V_{OUT}.

More particularly, the transresistance amplifying unit 420 comprises current mirrors 421-423 and a pass transistor 424. The current mirror 421 amplifies the current S_{I1} to generate processing current S_{IP1}. The current mirror 422 amplifies the current S_{I2} to generate processing current S_{IP2}. The current mirror 423 obtains the expanded current S_{IN} according to the processing current S_{IP2} and the processing current S_{IP1}. The pass transistor 424 generates the output voltage V_{OUT} according to the expanded current S_{IN}.

Since the operations of the feedback unit 430 and 230 are the same and the operations of the differential amplifying unit 440 and 240 are the same, descriptions of the feedback unit 430 and the differential amplifying unit 440 are omitted.

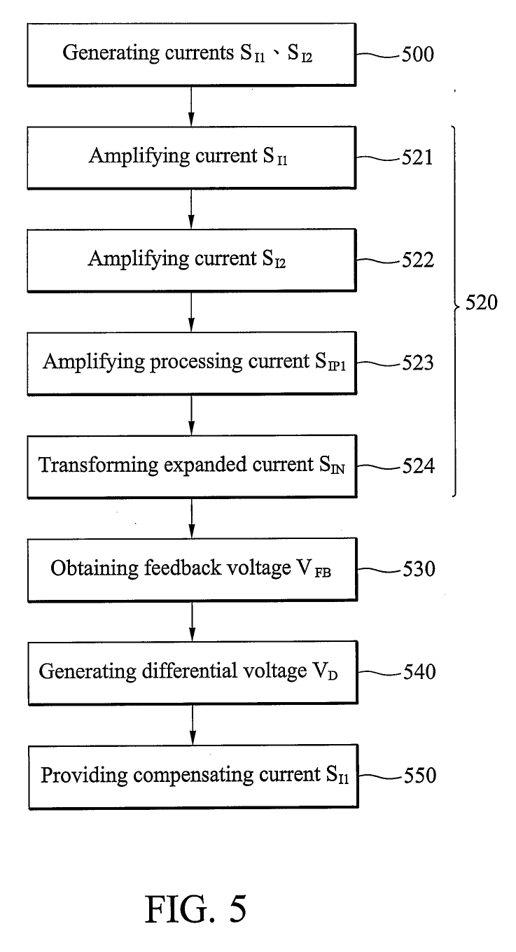

FIG. 5 is a flowchart of another exemplary embodiment of a compensation method. The compensation method is applied in a voltage regulator. With reference to FIG. 4a, currents S_{I1} and S_{I2} are generated according to the feedback voltage V_{FB} and the reference voltage V_{REF} (step 500). The transconductance amplifying unit 410, such as the transconductance amplifier 411, generates currents S_{I1} and S_{I2} according to a voltage difference between the feedback voltage V_{FB} and the reference voltage V_{REF}. The current S_{I1} is coupled to a first terminal of the compensation capacitor Cc.

The current S_{I1} is transformed into an output voltage V_{OUT} according to the current S_{I2} (step 520). In this embodiment, the current S_{I1} is amplified by the current mirror 421 to obtain a processing current S_{IP1} (step 521). The current S_{I2} is amplified by the current mirror 422 to obtain a processing current S_{IP2} (step 522) and then the processing current S_{IP1} is amplified by the current mirror 423 according to the processing current S_{IP2} for obtaining an expanded current S_{IN} (step 523). The expanded current S_{IN} is transformed to obtain the output voltage V_{OUT} (step 524). The feedback voltage V_{FB} is obtained according to the output voltage V_{OUT} (step 530). In this embodiment, the feedback voltage V_{FB} is obtained by voltage division of the output voltage V_{OUT}.

A differential voltage V_{D} is generated to a second terminal of the compensation capacitor Cc according to the feedback voltage V_{FB} and the reference voltage V_{REF} (step 540). In this embodiment, the differential voltage V_{D} is generated by the differential amplifying unit 440. The differential amplifying unit 440 generates the differential voltage V_{D} to the second terminal of the compensation capacitor Cc according to a voltage difference between the feedback voltage V_{FB} and the reference voltage V_{REF}. The differential amplifying unit 440 comprises a voltage amplifier, such as a differential amplifier, comprising an output terminal coupled to the second terminal of the compensation capacitor Cc. The first terminal of the compensation capacitor Cc is coupled to the current S_{I1} (step 550), thus forming a feedback loop. In this embodiment, the first terminal of the compensation capacitor Cc is coupled to the output T_{O2} of the transconductance amplifying unit 410, compensating the current S_{I1} through the compensation capacitor Cc.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A voltage regulator, comprising:
a transconductance amplifying unit having two inputs for receiving a feedback voltage and a reference voltage, and having a first output for outputting a first current;
a transresistance amplifying unit having a first input for receiving the first current, and transforming the first current into an output voltage;
a feedback unit generating the feedback voltage with reference to the output voltage;
a differential amplifying unit having two inputs for receiving the feedback voltage and the reference voltage, and having an output for outputting a differential voltage; and
a compensation capacitor, coupled between the output of the differential amplifying unit and the first input of the transresistance amplifying unit.

2. The voltage regulator as claimed in claim 1, wherein the feedback unit comprises a voltage divider, and the feedback voltage is generated by voltage division of the output voltage.

3. The voltage regulator as claimed in claim 1, wherein the transresistance amplifying unit comprises:
a current generator;
a current mirror obtaining an expanded current from the current generator according to the first current; and
a pass transistor generating the output voltage according to the expanded current.

4. The voltage regulator as claimed in claim 1, wherein the transconductance amplifying unit has a second output for outputting a second current, and transresistance amplifying unit has a second input for receiving the second current, and transforms the first current into the output voltage according to the second current.

5. The voltage regulator as claimed in claim 4, wherein the transresistance amplifying unit comprises:
a first current mirror generating a first processing current according to the first current;
a second current mirror generating a second processing current according to the second current;
a third current mirror obtaining an expanded current according to the second processing current and the first processing current; and
a pass transistor generating the output voltage according to the expanded current.

6. A compensation method for a voltage regulator, comprising:
generating a first current according to a feedback voltage and a reference voltage;
transforming the first current into an output voltage;
obtaining the feedback voltage with reference to the output voltage;
generating a differential voltage to one terminal of a capacitor according to the feedback voltage and the reference voltage; and
coupling another terminal of the capacitor to the first current.

7. The compensation method as claimed in claim 6, wherein the feedback voltage is generated by voltage division of the output voltage.

8. The compensation method as claimed in claim 6, wherein the differential voltage is generated by a differential amplifier according to a voltage difference between the feedback voltage and the reference voltage.

9. The compensation method as claimed in claim 6, wherein the step of transforming comprises:
obtaining an expanded current according to the first current by a current mirror; and
generating the output voltage according to the expanded current by a pass transistor.

10. The compensation method as claimed in claim 6, further comprising:
generating a second current according to the feedback voltage and the reference voltage; and
transforming the first current into the output voltage according to the second current.

11. The compensation method as claimed in claim 10, wherein the step of transforming comprises:
generating a first processing current according to the first current;
generating a second processing current according to the second current obtaining an expanded current according to the second processing current and the first processing current; and
generating the output voltage according to the expanded current.
